(19) United States
(12) Patent Application Publication
(10) Pub. No.: US 2011/0020071 A1
(43) Pub. Date: Jan. 27, 2011

(54) METHODS FOR DUST CONTROL USING MINIMAL WATER RESOURCES

(76) Inventor: DAVID GROENEVELD, SANTA FE, NM (US)

Correspondence Address: THE ADAMS KENNEDY LAW FIRM, LLC, 901 RIO GRANDE BLVD. NW, SUITE H262, ALBUQUERQUE, NM, 87111, US

(21) Appl. No.: 12/841,971

(22) Filed: Jul. 22, 2010

Related U.S. Application Data
(60) Provisional application No. 61/228,271, filed on Jul. 24, 2009.
(60) Provisional application No. 61/254,112, filed on Oct. 22, 2009.
(60) Provisional application No. 61/315,461, filed on Mar. 19, 2010.
(60) Provisional application No. 61/326,468, filed on Apr. 21, 2010.
(60) Provisional application No. 61/358,249, filed on Jun. 24, 2010.
(60) Provisional application No. 61/361,724, filed on Jul. 6, 2010.

(51) Int. Cl. E02D 3/00; C09K 17/00

(52) U.S. Cl. 405/263

(57) ABSTRACT

Aspects of the present invention include systems and methods for the use of brine from salt mined, dissolved and moved from a natural source deposit (an evaporite deposit) to create target deposits within wetting basins originally created and flooded with fresh water for the purpose of dust control. The target deposits can mimic the stable non-dust-emissive source deposit by having horizontal beds of precipitated salts with the most soluble salts retained within a brine solution that bathes and caps the salt deposit beneath to retain the deposit in a non-desiccated state. The method provides for the preparation and management of the lakebed surface using separate steps to prevent the release of windborne dust with a minimum of water used.

This application claims priority to the following: U.S. Provisional Patent Application Ser. No. 61/228,271 entitled “System and Method for Use of Natural Brine To Prevent Fugitive Dust Using Minimal Water,” filed on Jul. 24, 2009; U.S. Provisional Patent Application Ser. No. 61/254,112 entitled “System and Method for Use of Natural Brine To Prevent Fugitive Dust Using Minimal Water,” filed on Oct. 22, 2009; U.S. Provisional Patent Application Ser. No. 61/315,461 entitled “Method for Employing Clay for Construction of Low Cost Pond Liners,” filed on Mar. 19, 2010; U.S. Provisional Patent Application Ser. No. 61/326,468 entitled “Chloride Salts With Divalent Cations Provide Temporary Surface Stabilization in Saline Systems Dominated by Sodium,” filed on Apr. 21, 2010; U.S. Provisional Patent Application Ser. No. 61/358,249 entitled “Chloride Salts with Divalent Cations and Polyacrylamide Provide Temporary Surface Stabilization in Saline Systems Dominated by Sodium,” filed on Jun. 24, 2010; and U.S. Provisional Patent Application Ser. No. 61/361,724 entitled “Recharging Calcium Chloride Charged Brine to Seal Sulfate and Carbonate Salt Masses from Atmospheric Exposure,” filed on Jul. 6, 2010, the specification of each of which is incorporated herein by reference.

### BACKGROUND AND SUMMARY

The present invention relates generally to the field of ecological management, and more particularly to the field of improving air quality through dust control using minimal water resources.

The beds of drying bodies of water are potentially large sources of airborne dust that can cause extreme health and safety hazards within the surrounding areas. As an example, the Owens Dry Lake, Calif. is the historic terminus of the Owens River that was diverted by the City of Los Angeles for its water supply. Diversion of its supply caused the lake to desiccate early during the previous century. The salts contained in the naturally saline lake waters concentrated to form an evaporite deposit within the lakebed's lowest topography. The evaporite deposit consists of precipitated salts and salt held in concentrated aqueous solution. This aqueous solution is brine.

Federal and state laws mandate that the City of Los Angeles Department of Water and Power (LADWP) perform dust control for Owens Dry Lake, Calif., formerly the single largest source of respirable particulate air pollution in the United States. Through several decades of intensive study, only three methods have been identified: wetting the surface, covering the surface with vegetation, or covering the surface with gravel. Of these three, only surface wetting has been able to accomplish dust control within the time and scale required. Unfortunately, wetting of the Owens Lake surface is using enormous amounts of water that are projected by the LADPW to potentially grow to near 100,000 acre feet per year. Within the critically water-short semi-arid southern California region, supplying this amount of water for dust control is not sustainable.

Accordingly, the present invention includes systems and/or methods that (1) can protect the surface from releasing dust, (2) use the present infrastructure that was built to provide surface wetting, (3) consume minimal water resources for startup, and (4) consume little or no additional water for maintenance. The present invention relates to the use of brine from salt mined, dissolved and moved from a natural source deposit (an evaporite deposit) to create target deposits within wetting basins originally created and flooded with fresh water for the purpose of dust control. The target deposits can mimic the stable non-dust-emissive source deposit by having horizontal beds of precipitated salts with the most soluble salts retained within a brine solution that bathes and caps the salt deposit beneath to retain the deposit in a non-desiccated state. The method provides for the preparation and management of the lakebed surface using separate steps to prevent the release of windborne dust with a minimum of water used.

Aspects of the present invention are described with reference to preferred embodiments and example embodiments, all of which should be understood to be exemplary in nature and not limiting the scope of the present invention. A detailed description of the preferred embodiments and example embodiments follows below with reference to the following Figures.

### BRIEF DESCRIPTION OF THE DRAWINGS

FIG. 1 is a flowchart depicting a method of the preferred embodiment in accordance with one aspect of the present invention.

FIG. 2 is a flowchart depicting a method of the preferred embodiment in accordance with one aspect of the present invention.

FIG. 3 is a flowchart depicting a method of the preferred embodiment in accordance with one aspect of the present invention.

FIG. 4 is a flowchart depicting a method of the preferred embodiment in accordance with one aspect of the present invention.

FIG. 5 is a schematic cross-sectional view of a lakebed illustrating the water savings attributable to aspects of the present invention.

### DETAILED DESCRIPTION

As will be appreciated by one skilled in the art, aspects of the present invention may be embodied as a method, article of manufacture or a system configured to perform any method, steps or process specified and described herein.

### I. Preferred Embodiments

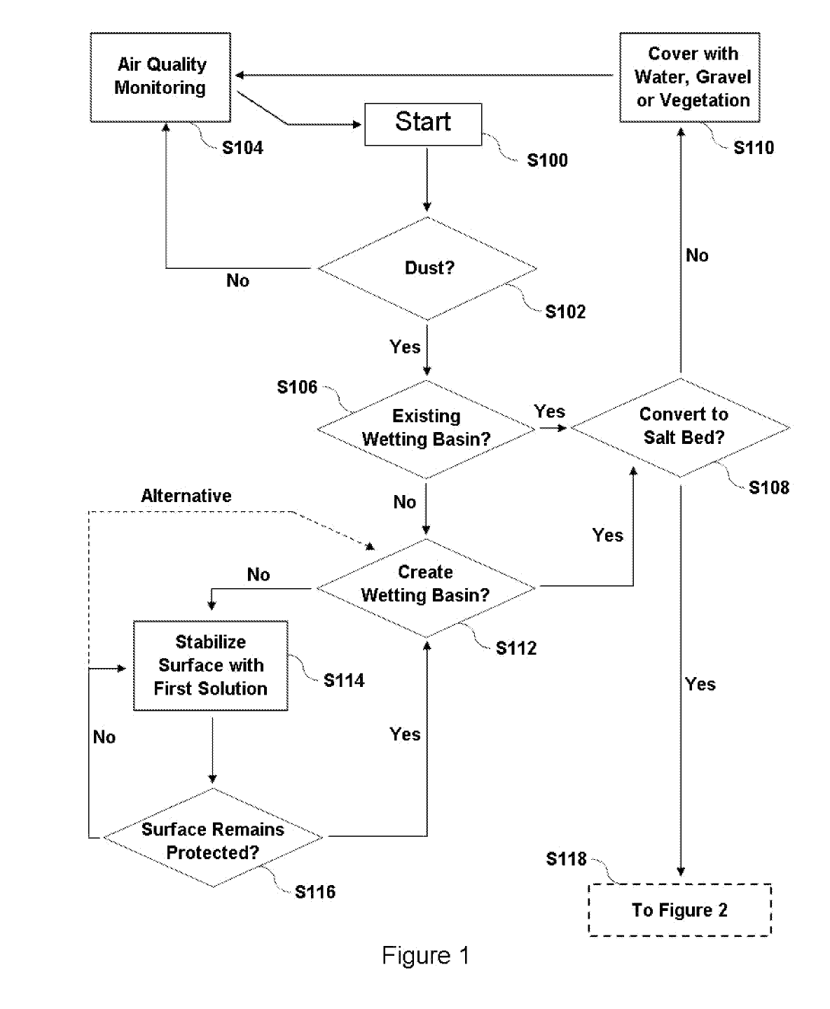

As shown in FIG. 1, a method of dust control in accordance with a preferred embodiment can begin at step S102, in which it is determined whether or not there is a dust issue relating to a region, such as a dry lakebed. As used herein, the term dust includes any particulate matter that is expelled or can be expelled into the atmosphere by wind or vehicle passage where it can be inhaled by humans or other animals. In the event that there is not a dust problem in the particular region, then the method of the preferred embodiment passes from air quality monitoring at step S104 and then returns to the beginning step at S100. Those of skill in the art will appreciate that implementation of the methods described herein will likely result in mitigation of any dust problems, but that any region should be continuously monitored for any deterioration resulting in dust pollution. Step 104 is the responsibility of the agency that monitors and manages the air quality of the lakebed and surrounding region.

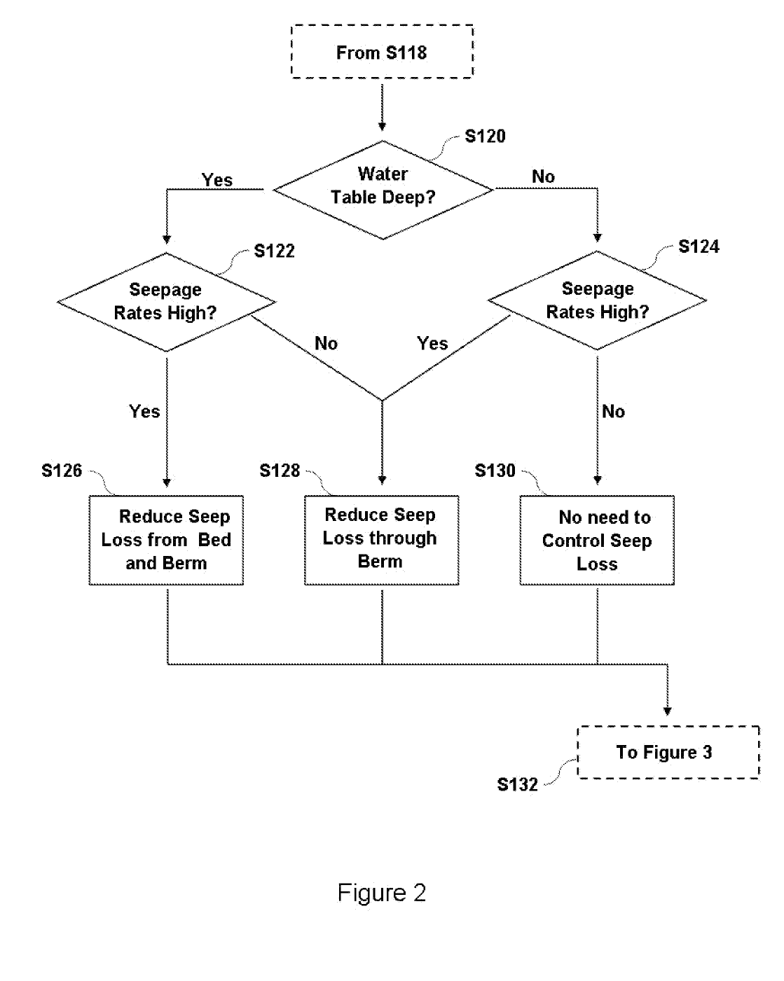

In step S106 of the method of the preferred embodiment queries whether there is an existing wetting basin. If the response is affirmative, then the method of the preferred embodiment proceeds to decision block S108, which queries whether it is possible to convert the region to a salt bed. If the response to query S108 is negative, then the method of the preferred embodiment proceeds to step S110, which recites mitigating any dust or erosion with water, gravel, vegetation or any suitable combination thereof. If the response to query S108 is affirmative, then the method of the preferred embodiment proceeds to step S118, which refers to FIG. 2, described in detail below.

Returning to decision block S106, if there is no existing wetting basin, then the method of the preferred embodiment proceeds to step S112, which queries whether a wetting basin can be created. If the response is affirmative, then the method of the preferred embodiment proceeds forward to step S108, discussed above. If the response is negative, then the method of the preferred embodiment proceeds to step S114, which recites stabilizing the surface with a first solution. The first solution can include one or more divalent cation salts and water-soluble polyacrylamide at a ratio sufficient to just induce the surface protection needed—various ionic strengths, ionic charges and molecular weights are available for polyacrylamide that can work for this application, the candidate formulations can undergo in situ testing to select the most effective type and concentration. In one variation of the method of the preferred embodiment, the divalent cation salts can include one or more chloride salts of divalent cations, including for example, calcium chloride and magnesium chloride. In another variation, the first solution includes a first portion including a salt solution of calcium chloride and/or magnesium chloride and a second portion including dissolved polyacrylamide. Other suitable salts and polymers can be used in conjunction with or as substitutes for the divalent cation salts and polyacrylamide polymer noted herein.

In one alternative to the preferred embodiment, the first solution can include an aqueous solution of one or more of calcium chloride and magnesium chloride with dissolved polyacrylamide. The first solution can be applied by spraying it directly onto the surface to be treated, such as a lakebed that contains sodium carbonate and sodium sulfate. The first solution will dissolve the salts in the lakebed and the divalent cations will form stable precipitates of carbonate and sulfate. The aforementioned chloride salts function to dissolve the existing salts in the lakebed, and the polyacrylamide functions to tack the precipitates and clays of the surface together increasing the stability thereof.

If the surface treated with the first solution is protected as shown in step S116 of the preferred embodiment, then the method proceeds to step S112, which again queries whether a wetting basin can be created. If the surface is unprotected, then the method returns to step S114, in which case the first solution is applied to the surface again to achieve greater stability. Alternatively, as shown in phantom in FIG. 1, the method of the preferred embodiment can proceed to step S112 even in the event that the surface is entirely stable.

If the wetting basin is to be converted to a salt bed as set forth in decision block S108, then the method of the preferred embodiment proceeds to FIG. 2. As shown in FIG. 2, step S120 queries whether the water table of the wetting basin is too deep. For example, in a dry lakebed the water table may be very close to the surface and/or the lakebed substrate may consist of fine clays. Under these conditions, seepage loss of brines from wetting basins is expected to be minimal. In these instances, the method of the preferred embodiment proceeds from step S120 to step S124 that queries whether the seepage rates are too high and concludes at step S130, which recites that there is no need to control seepage loss.

The relative depth of the water table is important because an extremely deep water table at Owens Lake, for example, over five feet deep, could provide sufficient void space to accept all of the infiltrating brine from the treated wetting basin. Likewise seepage rates are relative as well, and an extremely rapid seepage rate could cause the loss of brine in only a fraction of a year. In most cases, however, by their nature, dry saline lakes should have water tables relatively near the surface and seepage loss rates that are relatively low.

If the water table is deep and/or the potential for seepage loss from wetting basins is potentially high, then the method of the preferred embodiment can ameliorate these disadvantages to convert the region of interest to a salt bed. In order to understand these processes the water table position can be sequentially measured within and around each wetting basin or region of interest for conversion to a salt bed.

In one example environment, the water table is judged to be deep following step S120 and the seepage rate is high following step S122, in which case the method of the preferred embodiment proceeds to step S126, which recites reducing seepage loss through both the lakebed and outside enclosing berms. Alternatively, if the water table is too deep following step S120 and the seepage rate is low following step S122, then the method of the preferred embodiment proceeds to step S128, which recites reducing the seepage loss through the outside enclosing berms but not through the lakebed. Finally, in another alternative, if the water table is shallow following step S120, but the seepage rate is high following step S124, the method of the preferred embodiment again proceeds to step S128 reciting reducing the seepage loss through one or more berms but not the lakebed.

As noted above, in one aspect of the method of the preferred embodiment, treatment can include the step of reducing seepage loss through the lakebed and one or more berms. Treatment of the bed can include applying a second solution to the affected area, wherein the second solution can include at least clay and water. In a second alternative of the embodiment, the second solution can include clay suspension in aqueous solutions from the brine diverted from the source deposit surface or mined from the source deposit and subsequently dissolved. In a third alternative the clay suspension would include a surfactant, for example detergent to enhance grain-to-grain contact of the clay particles and to help reduce viscosity for spraying or other application method.

The second solution can be applied to the affected area by spraying or otherwise placing the second solution evenly over a surface to seal or retard seepage loss of water or other aqueous fluid placed within the wetting control basin. Alternatively, the second solution can be worked into the soil of the wetting control basin to enable the seal produced to be protected from physical disruption. Suitable methods for working the second solution into the soil include for example using manual or mechanized tools, such as rakes, tillers, earthmovers and the like.

In a variation of the method of the preferred embodiment, the second solution can be further subject to mechanical treatment using equipment to compact the surface with dimpling so that the second solution can puddle in the dimples and be thoroughly worked into the treated surface through multiple passes. Through this process, the second solution can be sprayed, worked into the soil, and resprayed and reworked until sufficient material impregnates the soil matrix to promote complete or near complete sealing. The degree of mixing necessary will be dependent upon the natural substrate requiring sealing and can be optimized in response thereto.

As noted above, step S126 recites that the treatment is applied to both the lakebed and outside enclosing berms of a wetting basin. It should be understood by those of skill in the art that in most instances, a berm can provide a primary opportunity for seepage loss because the berm is constructed artificially and, therefore, bypasses or otherwise disrupts the natural seepage resistance of the basin bottom. Accordingly, in another alternative to the preferred embodiment, each of the one or more existing berms enclosing wetting basins would receive treatment with the application and compaction of the second solution occurring on the berm face and within the sloped transition between the berm and the bed of the wetting basin. This alternative may also employ digging a trench at the base of an enclosing berm and puddling the second solution into the trench to provide a wall to cut off downgradient migration of the brine from a wetting basin. Specific focus will be paid to identify and mitigate potential seepage through existing berms that were constructed with engineering fabric bases, potentially serving as a pathway for seepage loss.

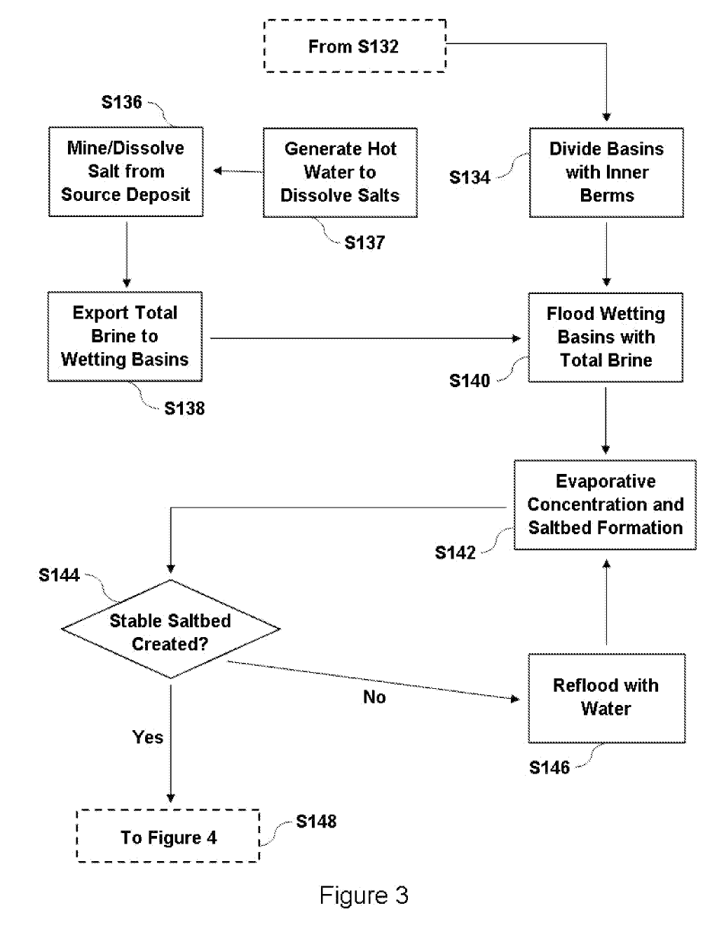

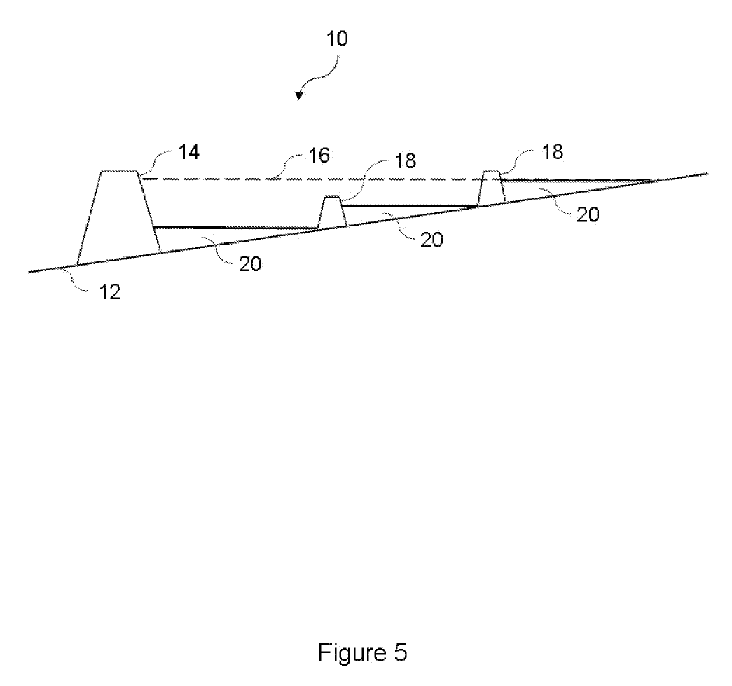

Each of steps S126, S128 and S130 proceeds to step S132, which in turn proceeds to FIG. 3. As shown in FIG. 3, the method of the preferred embodiment can include step S134, which recites dividing the wetting basin enclosed by outer berms with one or more inner berms. As shown in FIG. 5, a wetting basin 10 can include one or more inner or intermediate berms 18 created between the shore of the lakebed 12 and one or more existing outer berms 14. As shown, using only the existing outer berm 14 requires that the water level be maintained at a high level 16 (shown in phantom), which in turn would require a much larger volume of water or brine to fill. The method of the preferred embodiment substantially reduces conserves the brine needed to cover the enclosed surface by creating inner berms 18, which require that the water or brine be maintained at a lower depth 20, and consequently volume, to cover the surface of the entire wetting basin 12.

Step S136 of the method of the preferred embodiment recites mining and dissolving salt from a source deposit to create a brine solution, followed by step S138, which recites exporting the brine solution to the wetting basin. Suitable salts that can typically be found in dry lakebeds include sodium chloride, sodium carbonate, sodium bicarbonate and sodium sulfate. Heating of the water through passive solar or other means in Step S137 will permit rapid dissolution of the salts, especially sodium carbonate and sodium sulfate, salts whose solubilities are highly temperature dependent Given the potential corrosion and other destructive effects created by the brine solution, one alternative to the method of the preferred embodiment includes the step of diluting the brine solution to a predetermined level below saturation to facilitate safe movement of the salt load while avoiding the risk of temperature-induced salt precipitation that can destroy piping infrastructure by plugging. Alternatively, salt can be imported into the affected area by any known means, and the salt can be formed into brine either on site or distally from the wetting basin.

As shown in step S140, the brine solution can be applied to the wetting basin. Suitable means of application include spraying, flooding, or any other suitable means for dispersing liquid solutions upon a surface. In another alternative to the method of the preferred embodiment, the brine solution has a predetermined ratio of sodium chloride, sodium carbonate, sodium bicarbonate and sodium sulfate, such as that found in the source deposit, termed “total brine.” For example, total brine has the predetermined ratio of sodium chloride, sodium carbonate, sodium bicarbonate and sodium sulfate identical or substantially identical to the same ratio from a source deposit, which would typically be located at or near the wetting basin.

In another variation of the method of the preferred embodiment, the brine solution can be applied with inflow at the lowermost portion of the wetting basin in order to (1) add the brine solution in a manner that will minimize the surface area per depth ratio so as to reduce evaporation during filling, (2) reduce the potential for rill erosion, and (3) help achieve better mixing of the salts such that continuous, stable salt beds have better potential of developing.

Following application of the brine solution, step S142 of the method of the preferred embodiment permits evaporation to take effect and reduce the brine solution into stable horizontal beds of sodium carbonate, sodium bicarbonate, and sodium sulfate capped by a protective layer of remaining brine being dominated by sodium chloride. This occurs through evaporative concentration and salt precipitation. Sodium chloride generally remains in solution because it less soluble than other common sodium dominated salts found within dry lakes such as sodium carbonate, sodium bicarbonate, and sodium sulfate.

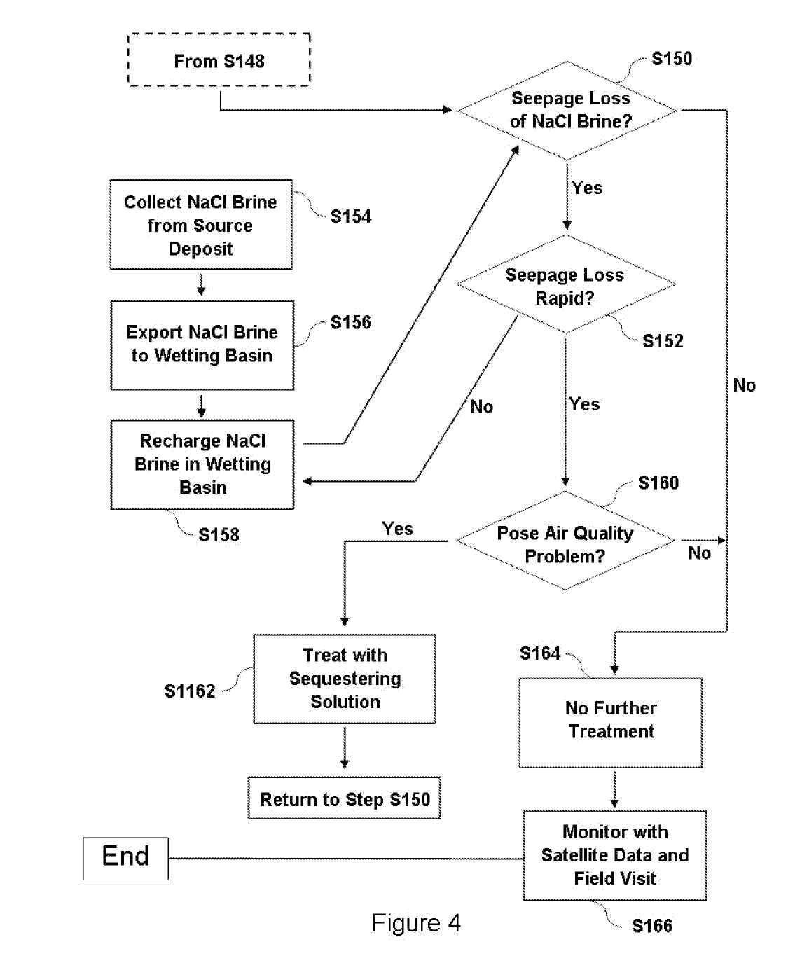

In step S144, the method of the preferred embodiment queries whether the flooding of the wetting basin has produced a stable salt bed. If the response is affirmative, then the method of the preferred embodiment proceeds to step S148 and to FIG. 4. If the response is negative, then the method of the preferred embodiment proceeds to step S146, in which the wetting basin is reflooded with water at a predetermined time that provides the correct temperatures, for example the autumn season after the heat of the summer season. Missing the desired stable endpoint of horizontal beds of precipitate and instead creating an undesirable condition of spatial fractionation of salt species can occur if the total brine evaporates while filling. This factor can be remedied at the time of brine entry by monitoring and increasing the proportion of water within the brine.

If the desired endpoint for stable salt beds was not reached after filling, reflooding a basin can restart the process. Once added, the newly introduced water will create an aqueous brine solution from the existing, recently applied salts, thereby starting the evaporation and precipitation process anew. Step S146 returns to step S142, in which the method of the preferred embodiment permits the evaporative concentration of the brine solution into salt beds.

As shown in FIG. 4, step S150 queries whether there is a seepage loss of the sodium chloride brine (wherein sodium chloride is abbreviated NaCl). Because the sodium chloride brine protects the surface from evaporation and from exposure of potential emissive salts of sodium carbonate and sodium sulfate, sodium chloride brine can be conserved. If the response is negative, then the method of the preferred embodiment proceeds to step S164, in which no further treatment is necessary, subject to the continued monitoring of the site with satellite data and field visits as shown in step S166. If the response to the query of step S150 is affirmative and there is seepage of the sodium chloride brine, then the method proceeds to step S152.

In order to ensure that there is sufficient sodium chloride in the brine solution to form the protective layer over the salt bed in the event of seepage losses, the method of the preferred embodiment would collect additional sodium chloride dominated brine from a source in step S154, such as for example, from natural brine overlying the source deposit that arises during periods of relatively high rain and snowfall and relatively low evaporation. Sodium chloride dominated brine can be readily captured using gravity and drainage channels, as well as other natural or man-made features or mechanisms for consolidating the desired brine in a particular location.

In addition to the export of total brine in Step S138, Step S156 of the method of the preferred embodiment recites exporting sodium chloride dominated brine to the wetting basin. As with the total brine, a suitable means for exporting the sodium chloride brine includes diluting the brine solution to a predetermined saturation so as not to adversely affect any machinery such as pumps, pipes or valves used to transport the fluid. Alternatively, sodium chloride can be imported into the affected area by any known means, and then be formed into brine either on site or distally from the wetting basin. Once the sodium chloride brine is at the wetting basin, the method of the preferred embodiment recites applying the sodium chloride dominated brine to at least a portion of the affected area having a predetermined high rate of seepage loss, thereby recharging the sodium chloride stores in the affected area, as shown in step S158. Alternatively, the sodium chloride brine solution can be applied with inflow from the lower end of the divided wetting basin bottom so as to (1) add the sodium chloride brine solution in a manner that will minimize the surface area per depth ratio so as to reduce evaporation during filling, (2) reduce the potential for rill erosion, and (3) help achieve better mixing of the salts such that continuous, stable salt beds have better potential of developing, as noted above.

Recharging of wetting basins with additional sodium chloride brine is intended to replace the brine lost to seepage that fills the void spaces in the soil below the lakebed surface and in most cases, this recharge is can suffice for more than one year. However, in the event that the seepage loss is too rapid as queried in step S152, the method of the preferred embodiment proceeds to step S160 in which it queries whether the seepage loss poses an air quality problem. That is, if the application and recharging of the brine solution is insufficient to maintain a protective layer of sodium chloride brine over the salt bed, then the method of the preferred embodiment queries whether the air quality is adversely affected from any resultant exposed potentially emissive surface. If the response to step S160 is negative, then the method of the preferred embodiment proceeds to step S164, in which no further treatment is necessary, subject to the continued monitoring of the site with satellite data and field data as shown in step S166. In this manner, even though S164 states that no further treatment may be necessary, the preferred embodiment recognizes the dynamic interplay of factors over time with active monitoring and field visits intended to identify and solve problems. From S166, the flow chart is intended to return to S150 and S160 if a problem is identified.

If the response to step S160 is affirmative, then the method of the preferred embodiment recites applying a sequestering solution to at least a portion of the affected area in step S162. A suitable sequestering solution includes divalent cations to sequester salts that are potentially dust emissive such as sodium carbonate and sodium sulfate, and create a surface layer of stable precipitated salts containing divalent cations, thereby stabilizing the salt beds by replacing the sodium salts with divalent salts that have less tendency to dissociate in a highly saline environment. Suitable divalent cations include calcium and magnesium, both of which are also suitable components for portions of the first solution noted above. One alternative means to apply the sequestering solution includes flooding the basin requiring treatment with a dilute solution of fresh water and calcium chloride or magnesium chloride. Other suitable means for application can also be used, for example spraying directly onto the surface.

Upon entry of the sequestering solution into the wetting basin, the calcium or magnesium ions will form stable precipitates with the carbonate and sulfate ions on the surface of the precipitated salt beds, thereby isolating these potentially emissive salts from the atmosphere. Upon drying, the surface of the salt mass will have a whiter appearance than the salt beds generated from the brine solution alone, and will also remain stable and non-emissive. A by-product of the reactions between the calcium and magnesium salts and the sodium salts is sodium chloride, which in turn is valuable in this system to aid retention of non-emissive properties within the treated wetting basins.

This diluted calcium chloride sequestering solution can be recharged during winter months so that the solubility of the sodium salts of carbonate and sulfate are depressed under cool temperatures and will have less potential for dissolution. Summertime application may also be possible given a sufficiently high salinity of the recharging solution that will inhibit such dissolution of the salt bed's layers of sodium carbonate and sulfate, even during warm solution temperatures.

Upon entry and bathing of the salt bed, the calcium chloride will remove any surface ions of carbonate and sulfate and form precipitates of calcium carbonate and calcium sulfate that will remain stable and insoluble within an arid hot-cold climate. Sodium chloride generated in this reaction will remain in solution and tend to provide a bathing brine as described above. The calcium carbonate and sulfate precipitates will coat the surface of the salt bed's layers and protect them from cycles of wetting and rewetting if they become desiccated. Excess calcium chloride is not anticipated, however, if it does occur, it will provide surface protection in the manner of the natural sodium chloride. Because of hyperconcentrations of sulfate and carbonate ions in the lakebed, excess calcium chloride that could seep from a wetting basin will form stable calcium carbonate and sulfates immediately below the wetting basin that may enhance sealing against further seepage loss. Periodic recharge with this variation of the method of the preferred embodiment may be desirable to maintain the surface in a non-dust emissive state. In another variation of the method of the preferred embodiment, polymers such as polyacrylamides may be added to the recharging calcium chloride solution in order to further stabilize the crust surface.

### II. Example Embodiments

Other features and embodiments of the present invention are described herein with reference to the particular site of Owens Lake, Calif. The system and method of the preferred embodiment is adapted for use in dust control wetting basins on the Owens Lake bed. The area of these basins was 34.7 square miles measured on Jun. 22, 2010 by Landsat™ satellite data used for monitoring wetting basin compliance.

The source of the salts used in the second solution and total brine solution of the preferred embodiment would come from the source evaporite deposit shown below in Table 1. These data resulted from over one thousand sampling boreholes made into the source deposit by three mining companies operating on Owens Lake over the past half century.

TABLE 1

| | AVERAGE % WT. |
|---|---|
| SOLID PHASE | |
| Na₂Co₃ | 41.5 |
| NaHCO₃ | 25.0 |
| NaCl | 2.6 |
| Na₂SO₄ | 12.4 |
| Insoluble | 9.1 |
| H₂O | 9.4 |
| BRINE PHASE | |
| Na₂Co₃ | 8.9 |
| NaHCO₃ | 0.2 |
| NaCl | 18.0 |
| Na₂SO₄ | 4.5 |
| H₂O | 68.4 |

A sufficient quantity of salt exists within the source evaporite deposit to supply all, or part of the existing approximately 35 square-mile surface of the wetting basins with brine solution, while also maintaining in situ, sufficient evaporite in the existing deposit to protect that surface from dust emissions. Following the methodology of the preferred embodiment ensures that salts from the source evaporite deposit would replace fresh water within the wetting basins in such a manner that the conditions within the created evaporite deposits in wetting basins maintain a stable non-emissive surface in the same manner as the source deposit.

The principal salts of the Owens Lake are formed by the cation sodium with the anions of carbonate, sulfate and chloride, listed in order of their representation shown in Table 1. Sodium sulfate and sodium carbonate change hydration state due to temperature and water availability. To move the massive quantities and of salts required for total brine, the source deposit may be mined mechanically. Because of temperature-dependent solubility, both sodium carbonate and sodium sulfate the principle components within the source deposit and within total brine, may be brought into solution using heated water. Passive solar collection is a convenient and inexpensive and practical method to generate sufficient hot water, however, other methods could be used to generate the hot water by burning fuel.

Especially following transitory wetting events of rain or snow, salts contained within the soil of the lakebed are first dissolved to then reprecipitate. With cool wintertime temperatures sodium carbonate and sodium sulfate precipitate as decahydrates that swell over four times their volume and fracture soil crusts. Subsequent dehydration of the salts during the frequently warm daytime temperatures causes formation of amorphous salts that occupy less physical space and lead to weakening and dispersing of the individual soil particles. This process ripens the lakebed surface to wind entrainment and is known to be the principal cause for the severe Owens Lake dust storms and the reason behind using water for dust control. Within the example embodiment sodium carbonate and sodium sulfate can be managed to remain aqueous, or if desiccated, positioned beneath sodium chloride or other sequestering layer: therefore non-emissive. Likewise, these salts can be managed to present a sufficiently thick layer so that soil can be isolated from exposure to wind.

The source evaporite deposit consists of massively precipitated salts to a depth of three meters. Seasonally, and generally during the winter months that have lower evaporative demand and higher precipitation, water received by the evaporite deposit from direct precipitation and inflow of surface and ground water causes some of the salts within the deposit to dissolve. The supernatant brine is dominated by sodium chloride that then ponds atop the deposit where it can be used by the methods described above with respect to the preferred embodiment; exported to be replacement brine for that lost through seepage from dust control wetting basins. The example embodiment effectively renders this brine a new source of water for dust control, thereby also lessening the demand for additional fresh water for dust control. This brine can be collected and applied subject to leaving sufficient sodium chloride within the source deposit to protect that body from potential dust emission.

As noted above, collection of the brine, created either by regional runoff and precipitation or from a process of mining, can occur beginning near the lowest portion of the evaporite pond in the general region of the thickest portion of the evaporite deposit. This is potentially the lowest portion of the lakebed and sodium chloride dominated brine can be induced to drain toward this region. From there sodium chloride dominated brine can be moved by pumping to tie in with new or existing piping and infrastructure to enable transport around the lake margin to serve any, and all, of the wetting basins.

Furthermore, the example embodiment can include that the total brine and naturally generated sodium chloride dominated brine be moved in an aqueous form through existing or new pumps, valves and piping to the locations where it would be released into the dust control wetting basins. Temperatures control the content of salts at saturation and falling temperatures may cause problematic precipitation of salt within the pumps, pipes and valving constructed (or adapted) to move the brine solution. Within the example embodiment, both the total brine and the naturally generated sodium chloride brine solution can be blended as needed with a small percentage of fresh water to reduce the salt content sufficiently below the point of saturation to form a safety margin to protect the necessary pumps, valving and piping from any and all effects of salt precipitation due to saturation levels and temperature changes.

Another feature of the example embodiment that is usable at Owens Lake is the retrofitting of the existing wetting basins with small interior berms constructed using the proximal native lakebed. These interior berms can have two functions: (1) built parallel to the contour, interior berms can break up the distance for ponding across a surface and, thus reduce the amount of brine necessary to be moved to protect the surface as is shown in FIG. 5, and (2) to break up wind fetch so that, at saturation, salts can precipitate and settle naturally to eventually create a stable horizontal surface. Furthermore, the example embodiment can employ the natural process wherein interior berms can absorb the sodium chloride-dominated brine bathing the created salt deposit through capillarity and these salts can render the berm resistant to erosion.

Like the preferred embodiment, the example embodiment can employ the natural process of evaporation, concentration of the brine to saturation, and salt precipitation to eventually form horizontal layers of precipitated salts with only a shallow layer of supernatant sodium chloride-dominated brine atop. Therefore, no wave erosion is likely to affect the berms that enclose dust-control wetting cells filled with brine.

Owens Lake dust control efforts have constructed substantial infrastructure. The example embodiment can use that existing infrastructure for the distribution of the brine solution into the wetting basins. The recharge of brine into the wetting cells can be controlled by the addition of pipe that is valved along its length to provide for input of brine solutions and fresh water while enabling complete drainage to protect the pipe from precipitation of salts in the event of dropping temperatures. This pipe can be the point of inflow for recharging a wetting basin with brine and can be located along the lowermost berm in the deepest portion of the wetting basin. This aspect of the example embodiment can control the inflow of brine so that it gently floods across the surface from the lower portion of the basin, thus preventing the erosion or dissolution of precipitated layers that have been created. Such dissolution would create rills eroded through the salts if fresh water or sub-saturated brine were recharged at the upper end of the wetting basin and allowed to flow down any appreciable gradient. Such erosion could expose the lakebed soil to possibly become dust-emissive. An alternative method for supply brine may consist of open ditches, where practical, since such ditches are less subject to functional impairment by temperature-induced salt precipitation.

The example embodiment can include management to create stable horizontal layers with surfaces of supernatant sodium chloride brine within each wetting basin. The less soluble salts will precipitate through the action of evaporative concentration to build the desired horizontal surface within weeks to months. The process of salt precipitation is temperature controlled and can occur most readily during winter. During summer the precipitated salts can remain stable below a surface zone because hot surface temperatures due to solar heating dampen off quickly with depth.

Thin surface crusts will naturally form atop the supernatant sodium chloride brine to protect each wetting basin from evaporation, thereby limiting or eliminating requirement for addition of replacement brine or water. This part of the example embodiment can ensure that there can be significant water savings through replacement of fresh water with brine. Using the interstitial brine concentration within the evaporite deposit as a model, replacement amounts for the water within the brine can be inches per season, rather than the four feet depth that is used in planning calculations by LADWP. The required hydration used by the example method can potentially be supplied by rain or snowfall, substantially eliminating the need to consume additional fresh water in the protection of the Owens Lake bed.

The terminology used herein is for the purpose of describing particular embodiments only and is not intended to be limiting of the invention. As used herein, the singular terms “a”, “an” and “the” are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements and specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The preferred embodiment and the example embodiment were chosen and described in order to best explain the principles of the invention and the practical applications, and to enable others of ordinary skill in the art to understand the invention for various embodiments with various modifications as are suited to the particular use contemplated.

What is claimed is:

1. A method of dust control comprising:
applying a first solution comprising divalent cation salts and water-soluble polyacrylamide to an affected area.

2. The method of claim 1, wherein the divalent cation salts comprises chloride salts of divalent cations.

3. The method of claim 2, wherein the chloride salts of divalent cations comprises calcium chloride and magnesium chloride.

4. The method of claim 1, wherein the first solution comprises a first portion comprising a salt solution of calcium chloride and magnesium chloride and a second portion comprising dissolved polyacrylamide.

5. The method of claim 1, further comprising: creating a wetting basin at the affected area.

6. The method of claim 5, further comprising: in response to a predetermined depth of a water table beneath the affected area and a seepage rate of the affected area, applying a second solution comprising clay to the affected area.

7. The method of claim 6, further comprising: applying a third solution comprising one of sodium carbonate, sodium bicarbonate or sodium sulfate.

8. The method of claim 5, further comprising: creating an inner berm in the wetting basin.

9. The method of claim 5, further comprising: applying a brine solution to the affected area, the brine solution comprising a predetermined ratio of sodium chloride, sodium carbonate, sodium bicarbonate and sodium sulfate.

10. The method of claim 9, wherein the predetermined ratio of sodium chloride, sodium carbonate, sodium bicarbonate and sodium sulfate comprises a source deposit ratio.

11. The method of claim 9, further comprising: determining whether the application of the brine solution to the affected area results in a stable salt bed.

12. The method of claim 11, further comprising: reapplying a second brine solution to the affected area in response to the brine solution not resulting in a stable salt bed.

13. The method of claim 8, further comprising: applying a brine solution to the affected area, the brine solution comprising a predetermined ratio of sodium chloride, sodium carbonate, sodium bicarbonate and sodium sulfate.

14. The method of claim 13, wherein the predetermined ratio of sodium chloride, sodium carbonate, sodium bicarbonate and sodium sulfate comprises a source deposit ratio.

15. The method of claim 13, further comprising: determining whether the application of the brine solution to the affected area results in a stable salt bed.

16. The method of claim 15, further comprising: reapplying a second brine solution to the affected area in response to the brine solution not resulting in a stable salt bed.

17. The method of claim 5, further comprising: applying a sodium chloride dominated brine to at least a portion of the affected area having a predetermined rate of seepage loss.

18. The method of claim 17, further comprising: applying a sequestering solution to the at least a portion of the affected area, the sequestering solution comprising divalent cations to sequester the sodium carbonate and sodium sulfate and create stable divalent cation salts.

19. A method of dust control comprising:
creating an inner berm in a wetting basin;
applying a brine solution to an affected area, the brine solution comprising a predetermined ratio of sodium chloride, sodium carbonate, sodium bicarbonate and sodium sulfate; and
determining whether the application of the brine solution to the affected area results in a stable salt bed.

20. A method of dust control comprising:
applying a brine solution to an affected area, the brine solution comprising a predetermined ratio of sodium chloride, sodium carbonate, sodium bicarbonate and sodium sulfate.
